(19) United States
(12) Patent Application Publication
(10) Pub. No.: US 2005/0168774 A1
(43) Pub. Date: Aug. 4, 2005

(54) Network facsimile machine and network facsimile communication method

(75) Inventors: Masashi Eguchi, Joyo-shi (JP); Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/038,430

(22) Filed: Jan. 21, 2005

(30) Foreign Application Priority Data
Jan. 30, 2004 (JP) 2004-024345

(51) Int. Cl. G06F 15/00; H04N 1/00

(52) U.S. Cl. 358/1.15; 358/400

(57) ABSTRACT

A network facsimile machine accepts designation information for designating information to be embedded in image data of a transmission original document, presents the accepted designation information to a remote device, acquires information as a response and generates image data in which the acquired information is embedded in the transmission original document.

### BACKGROUND OF THE INVENTION

1. Field of the Invention

The present invention relates to a network facsimile machine connected to a computer network. More specifically, the present invention relates to a network facsimile machine and a network facsimile communication method having a function for adding a Transmit Terminal Identifier (TTI) or a cover page to a transmission original document.

2. Description of Related Art

Recently, many network facsimile machines include a function for transmitting image data of the TTI by adding the image data of the TTI to image data of an original document. Some of the facsimile machines include a function for adding image data of a cover page created in a client Personal Computer (PC) to image data of a transmission original document.

The TTI includes information such as a transmitter facsimile number, a transmitter name (in case the transmitter is a company, a company name, a department name and a name of a person in charge, etc.) and a transmission date and time. In general, information registered as device setting information in a network facsimile machine is fetched at a facsimile transmission and embedded as a part of the image data of the transmission original document. A commercially available network facsimile machine can register a plurality of TTIs. In such a network facsimile machine, according to a transmission destination, a user can select one TTI from the plurality of the registered TTIs and add the selected TTI to the transmission original document.

A function for selecting a plurality of TTIs is convenient when a network facsimile machine is used by a plurality of users, for example, when the network facsimile machine is provided in a company. That is, as a transmitter name of the TTI, apart from the company name, a different department name or a different name of a person in charge or the like can be registered for each user. Accordingly, when carrying out a transmission operation, the user can select the TTI of the user and add the selected TTI to the transmission original document. As a result, detailed information such as the department name and the name of a person in charge can be transmitted to the transmission destination.

A cover page includes information such as a subject, a greeting, a destination name and a transmitter name (in case the user is a company or the like, a company name, a department name and a name of a person in charge, etc.). The destination name or the like differs according to the transmission destination. Therefore, at least the destination name or the like is required to be changed for each transmission destination. Thus, conventionally, the user creates an entire cover page by a word processor software or the like and adds the cover page to a front page of the transmission original document. Then, the user carries out a facsimile transmission. In a conventional network facsimile machine/client PC system, a template of a plurality of cover pages having different greetings and designs is previously registered in the client PC. A user can select a cover page, and the selected cover page including a greeting and a design desired by the user can be added to a front page of the transmission original document. However, also in this case, a destination name or the like of the cover page is required to be input by the user for each destination. In a company or the like, a department name and a name of the person in charge are required to be input as a transmitter name of the cover page.

As described above, the user is required to input the information such as the destination name and the transmitter name (for example, a department name and a name of a person in charge) of the cover page, which is required to be changed for each destination. As a result, the transmission operation is complicated. Consequently, a network facsimile machine stores a plurality of registrations of the information such as the destination name and the transmitter name, which are required to be changed for each destination. The user can select information and the selected information can be embedded in the template of the cover page. Accordingly, image data of the cover page including the destination name and the transmitter name is generated. As a consequence, in the same manner as when selecting a plurality of registered TTIs, without carrying out a troublesome input operation of a character string, each user can add an original cover page and carry out a transmission.

However, by registering for each user, a plurality of information such as the transmitter name to be embedded in the cover page or the TTI and information such as the destination name to be embedded in the cover page, there are drawbacks that a large capacity of a storage resource is required to be secured for the registration and a manufacturing cost of the network facsimile machine increases.

In a company or the like having a plurality of network facsimile machines, there are cases in which a worker is replaced by entering or resigning the company, a department name of a department where a worker belongs changes or a number of clients changes. Each time when there is a change, the registered information to be embedded in the cover page or the TTI is required to be updated for each network facsimile machine. Accordingly, there is a drawback of an increase in a management load of the registered information.

### SUMMARY OF THE INVENTION

The present invention has been made in consideration to the above-described circumstances. An advantage of the present invention is to provide a network facsimile machine which can create a TTI or a cover page corresponding to each of a plurality of destination names and transmitter names or the like by a simple operation without placing a load on a storage resource of the network facsimile machine and which can embed the created cover page in image data of a transmission original document. Another advantage of the present invention is to provide a network facsimile machine which can reduce a management load of information to be embedded in the TTI or the cover page for a user having a plurality of network facsimile machines.

According to a first aspect of the present invention, a network facsimile machine accepts designation information for designating information to be embedded in image data of a transmission original document. The network facsimile machine presents the accepted designation information to a remote device and as a response, acquires information. The network facsimile machine generates image data in which the acquired information is embedded in the transmission original document.

According to a second aspect of the present invention, in the generation of the image data, the acquired information is embedded as a part of the TTI of the transmission original document.

According to a third aspect of the present invention, in the generation of the image data, the acquired information is embedded as a part of the cover page of the transmission original document.

According to a fourth aspect of the present invention, the network facsimile machine accepts designation information for designating information to be transmitted along with the image data of the original document. The network facsimile machine presents the accepted designation information to a remote device and as a response, acquires information. The network facsimile machine transmits the acquired information along with the image data of the original document.

According to a fifth aspect of the present invention, the designation information is designation information for designating a TSI (Transmitting Subscriber Identification) and the acquired information is transmitted as the TSI.

According to the present invention, information relating to a transmitter (for example, a company name, a department name and a name of a person in charge) and information relating to a destination (for example, a company name, a department name and a name of a person in charge) can be registered in a remote device. Therefore, without placing a load on the storage resource of the network facsimile machine, a TTI or a cover page corresponding to each of a plurality of destination names and transmitter names or the like can be created by a simple operation and embedded in the image data of the transmission original document. With respect to the information such as the TSI which is transmitted to the destination along with the image data, without placing a load on the storage resource of the network facsimile machine, information corresponding to each of the plurality of the destination names and the transmitter names or the like can be selected by a simple operation. According to the present invention, the information registered in the remote device is acquired as information to be embedded in the TTI or the cover page. Accordingly, a user having a plurality of network facsimile machines can reduce a management load of the registered information by using one remote device.

### BRIEF DESCRIPTION OF THE SEVERAL VIEWS OF THE DRAWINGS

FIG. 1 is a block diagram showing an example of a structure of a network facsimile machine according to an embodiment of the present invention.

FIG. 2 shows an example of a content of a directory management database.

FIG. 3 is a schematic drawing showing information exchanged between the network facsimile machine and a directory server according to an embodiment of the present invention.

FIG. 4 is a flowchart showing processes carried out with a directory server when the network facsimile machine carries out a facsimile transmission by using a cover page adding function and a TTI adding function according to a first embodiment of the present invention.

FIG. 5A shows an example of cover page information.

FIG. 5B shows an example of a selection screen of TTI information.

FIG. 6 is a flowchart showing processes carried out with the directory server when the network facsimile machine carries out a facsimile transmission from a client PC by using the cover page adding function and the TTI adding function according to the first embodiment of the present invention.

FIG. 7 is a flowchart showing processes carried out with the directory server when the network facsimile machine carries out a facsimile transmission by using the cover page adding function and the TTI adding function according to a second embodiment of the present invention.

FIG. 8 shows an example of a confirmation screen of cover page information and TTI information.

FIG. 9 is a flowchart showing processes carried out with the directory server when the network facsimile machine carries out a facsimile transmission from a client PC by using the cover page adding function and the TTI adding function according to the second embodiment of the present invention.

### DETAILED DESCRIPTION OF THE INVENTION

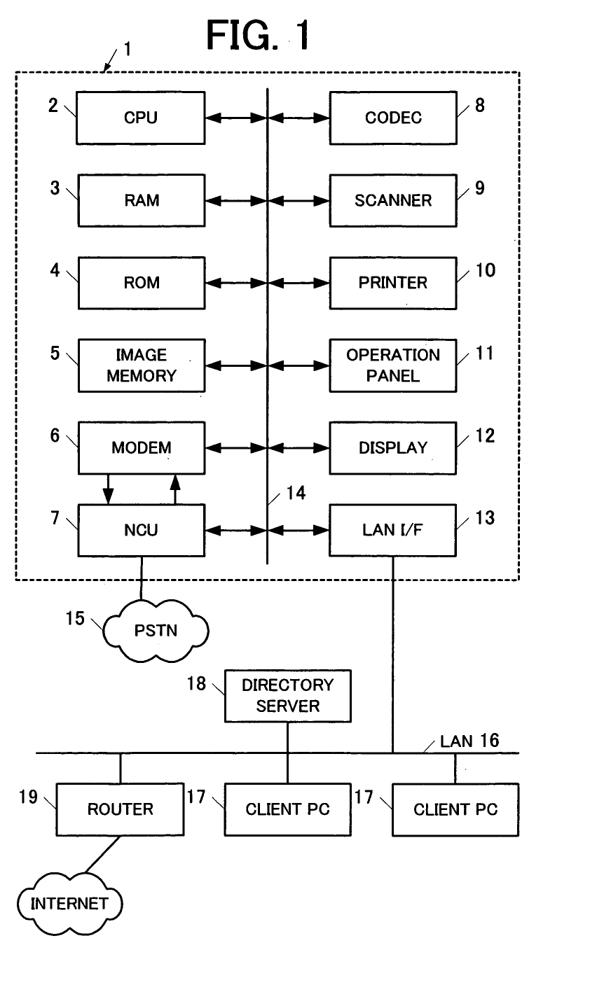

A network facsimile machine according to a first embodiment of the present invention will be described with reference to the drawings. FIG. 1 shows an example of a structure of a network facsimile machine 1 according to the first embodiment of the present invention. That is, the network facsimile machine 1 includes a Central Processing Unit (CPU) 2, a Random Access Memory (RAM) 3, a Read Only Memory (ROM) 4, an image memory 5, a modulator-demodulator (MODEM) 6, a Network Control Unit (NCU) 7, a coder-decoder (CODEC) 8, a scanner 9, a printer 10, an operation panel 11, a display 12 and a Local Area Network Interface (LAN I/F) 13. Each of the units 2 through 13 are connected by a bus 14.

The CPU 2 controls each of the units of the network facsimile machine 1 in accordance with a control program stored in the ROM 4. The RAM 3 functions as a main memory and a working area or the like of the CPU 2. The ROM 4 stores the control program. The image memory 5 accumulates received image data and image data scanned by the scanner 10 or the like.

The MODEM 6 modulates transmission data and demodulates received data in accordance with, for example, the International Telecommunication Union-Telecommunications (ITU-T) Recommendation V. 34 standard or anything similar to this. The NCU 7 controls a telephone line to make and disconnect a telephone call. The NCU 7 is connected to a Public Switched Telephone Network (PSTN) 15. The CODEC 8 encodes and decodes image data. That is, for transmitting image data of an original document scanned by the scanner 9, the CODEC 8 encodes the image data in accordance with the Modified Huffman (MH), Modified Read (MR) scheme or the like. The CODEC 8 decodes image data received from a remote device.

The scanner 9 scans image data of an original document. For example, the scanner 9 includes a Charge Coupled Device (CCD) color line sensor, an Analog-to-Digital (A/D) converter and an image processor or the like. The printer 10 carries out an image forming process of the received image data or the like onto printing paper. For example, the printer 10 is an electrophotographic printer. The operation panel 11 includes an input key for a user to input information of a character string or the like, a cursor key for moving a cursor displayed on the display 12 or the like. The user carries out various operations from the operation panel 11. The display 12 is, for example, a Liquid Crystal Display (LCD) provided in proximity to the operation panel 11. The display 12 displays various pieces of screen information. The LAN I/F 13 connects the network facsimile machine 1 and a LAN 16 in a manner that a communication can be carried out.

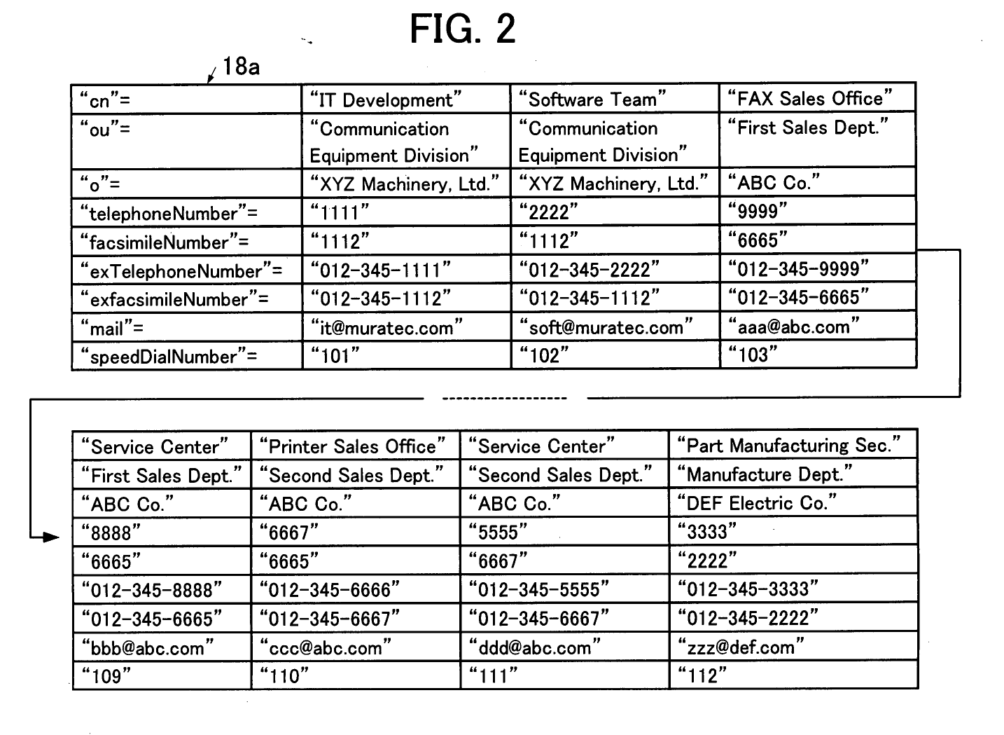

For example, a client PC 17, a directory server 18 that provides a directory service, a router 19 or the like are connected to the LAN 16. The directory server 18 includes a directory management database 18a as shown in FIG. 2 as an example. Attribute information such as “cn”, “ou”, “o”, “telephoneNumber”, “facsimileNumber”, “exTelephoneNumber”, “exfacsimileNumber”, “mail” and “speedDialNumer” are registered in the database 18a. The network facsimile machine 1 accesses the database 18a by a Lightweight Directory Access Protocol (LDAP) or the like and acquires various pieces of registered information.

In the database 18a shown in FIG. 2, a department name is registered by being associated with “cn”. A division name of a company is registered by being associated with “ou”. A company name is registered by being associated with “o”. An extension telephone number is registered by being associated with “telephoneNumber”. An external telephone number is registered by being associated with “exTelephoneNumber”. An extension facsimile number is registered by being associated with “facsimileNumber”. An external facsimile number is registered by being associated with “exfacsimileNumber”. An electronic mail address is registered by being associated with “mail”. A speed dial number is registered by being associated with “speedDialNumber”. There are cases in which same information is stored in “cn”, “ou”, “o”, “telephoneNumber”, “facsimileNumber”, “exTelephoneNumber”, “exfacsimileNumber” and “mail”. However, in “speedDialNumber”, different speed dial numbers are registered. The information registered in the “speedDialNumber” corresponds with a speed dial number of the network facsimile machine 1. Further, the attribute information registered in the database 18 is not limited to these examples and other various pieces of information can be registered as the attribute information. For example, a Transmitting Subscriber Identification (TSI), which is transmitted to a destination in a facsimile transmission protocol, can be registered as the attribute information of the database 18 (for example ““attribute information”=”).

The above-described network facsimile machine 1 includes a communication function for transmitting and receiving image data, such as a facsimile communication function and an Internet facsimile communication function (a mail server function). The network facsimile machine 1 also includes a cover page adding function for adding a cover page to an original document to be transmitted by the communication function and a TTI adding function for adding the TTI.

According to the cover page adding function and the TTI adding function, by a prescribed operation of a user, designation information designated by the user is presented to the directory server 18, and information acquired as a response is applied as information of a cover page (for example, information indicating a destination section and a transmitter section, etc.) and information indicating a transmitter name of the TSI.

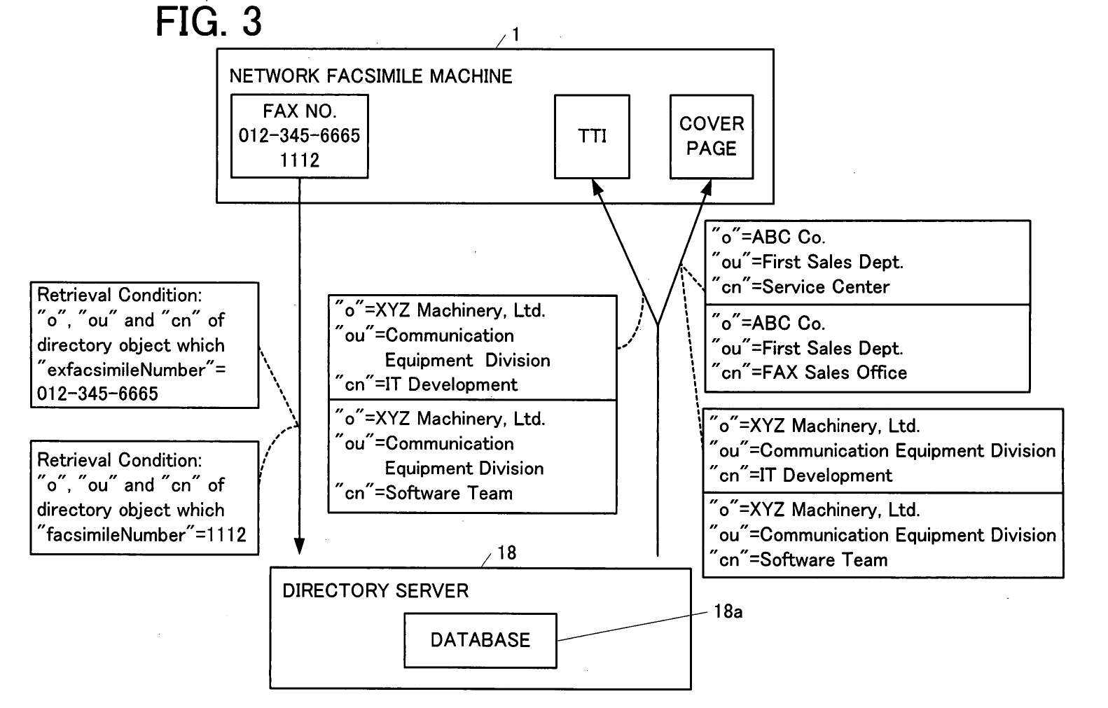

Referring to FIG. 3, the network facsimile machine 1 presents to the directory server 18, the designation information input and designated by the user. For example, the designation information is a destination facsimile number “012-345-6665” and a facsimile number of a terminal of the user “1112”. When presenting the designation information, a retrieval condition is presented for retrieving the attribute information ““o”, “ou” and “cn”” of a directory object including the same information as the designation information in the attribute information “facsimileNumber” or “exfacsimileNumber”. As a response, the attribute information ““o”, “ou” and “cn”” of the destination or the transmitter corresponding to the designation information is acquired and applied to the cover page or the TTI. Further, when carrying out an Internet facsimile transmission, an electronic mail address can be adopted as the designation information.

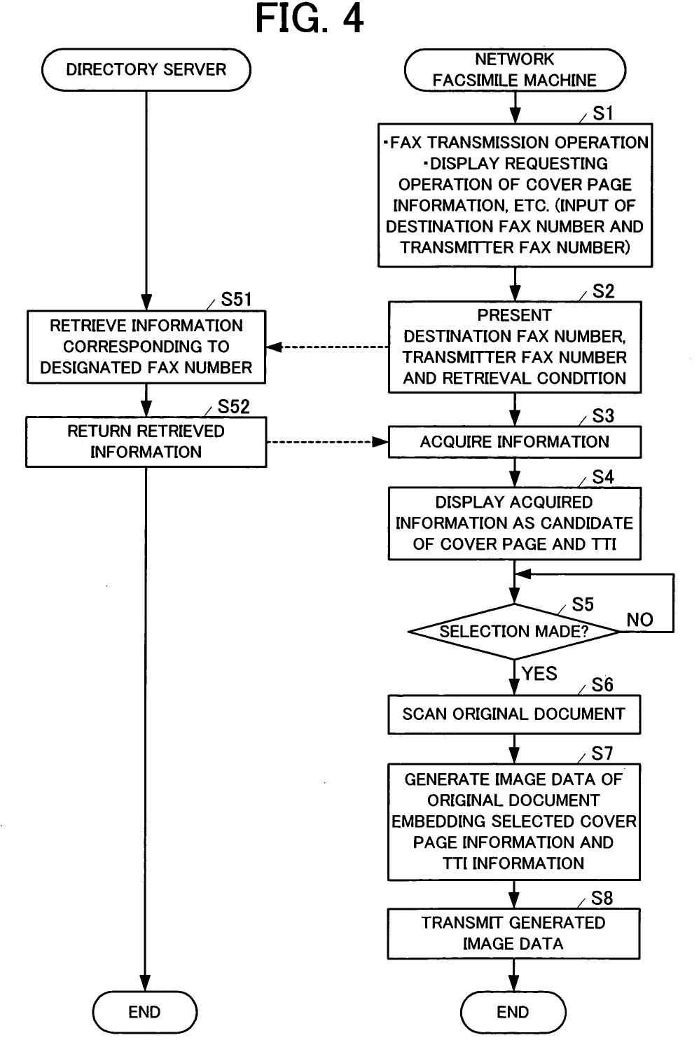

Referring to FIGS. 3 and 4, a processing operation when the network facsimile machine 1 executes the cover page adding function and the TTI adding function will be described. Further, processes of the network facsimile machine 1 to be described with reference to FIG. 4 are carried out in accordance with a command generated by the CPU 2 in accordance with the control program stored in the ROM 4.

First, a description will be made of a case in which the user transmits an original document by using the cover page adding function and the TTI adding function of the network facsimile machine 1. Further, in the present embodiment, the transmission is carried out as a facsimile transmission. However, the facsimile transmission is one example of a communication method. The transmission can be carried out by an Internet facsimile transmission or other transmission methods.

A user sets an original document at the scanner 9. In addition to a general facsimile transmission operation such as an input operation of a destination facsimile number, a prescribed operation is carried out for requesting a display of the cover page information and the TTI information. In the prescribed operation, as designation information for designating information to be embedded in the image data of the transmission original document, the destination facsimile number and the transmitter facsimile number are designated by the input operation of the user separately or at the same time with respect to the transmission operation. The network facsimile machine 1 accepts an instruction and a facsimile number by these operations (step S1).

The destination facsimile number and the transmitter facsimile number are examples of the designation information. A keyword consisting of an appropriate character string or the like can be adopted in place of the destination facsimile number and the transmitter facsimile number. In case the TSI is registered in the database 18a of the directory server 18, in the prescribed operation, as the designation information for designating information to be transmitted along with the image data of the transmission original document, a prescribed keyword (for example, an appropriate character string; can be the destination facsimile number or the like) corresponding to the TSI on the database 18a is designated by the input operation of the user. The network facsimile machine 1 can accept the keyword and present the keyword to the directory server 18 as the same designation information as the transmitter facsimile number. Then, the network facsimile machine 1 can acquire the registered TSI.

Subsequent to the process of step S1, the network facsimile machine 1 presents the accepted two facsimile numbers and the retrieval condition to the directory server 18, which is a remote device, by the LDAP or the like (step S2). The retrieval condition requests information attributing to the directory object including the facsimile numbers acquired at step S1. For example, in case the directory server 18 includes the database 18a as shown in FIG. 2 and the network facsimile machine 1 accepted the destination facsimile number “012-345-6665” and the transmitter facsimile number “1112” as the designation information, as shown in FIG. 3, the network facsimile machine 1 presents to the directory server 18, a retrieval condition for retrieving ““o”, “ou” and “cn”” of the directory object which ““exfacsimileNumber”=012-345-6665”.

As a response, the directory server 18 returns as a retrieval result, ““o”=“ABC Co.”, “ou”=“First Sales Dept.” and “cn”=“FAX Sales Office”” and ““o”=“ABC Co.”, “ou”=“First Sales Dept.” and “cn”=“Service Center””. When the network facsimile machine 1 presents to the directory server 18, the retrieval condition for retrieving ““o”, “ou” and “cn”” of the directory object which ““facsimileNumber”=1112”, as a response, the directory server 18 returns as a retrieval result, ““o”=“XYZ Machinery, Ltd.”, “ou”=“Communication Equipment Division” and “cn”=“IT Development”” and ““o”=“XYZ Machinery, Ltd.”, “ou”=“Communication Equipment Division” and “cn”=“Software Team””.

In the database 18a, the directory server 18 retrieves a company name, a department name and a division name or the like of the destination or the transmitter, which is the information corresponding to the facsimile number designated by the network facsimile machine 1, in other words, information attributing to the directory object having the facsimile number as the attribute information (step S51). The directory server 18 returns the retrieved information as a retrieval result to the network facsimile machine 1 (step S52).

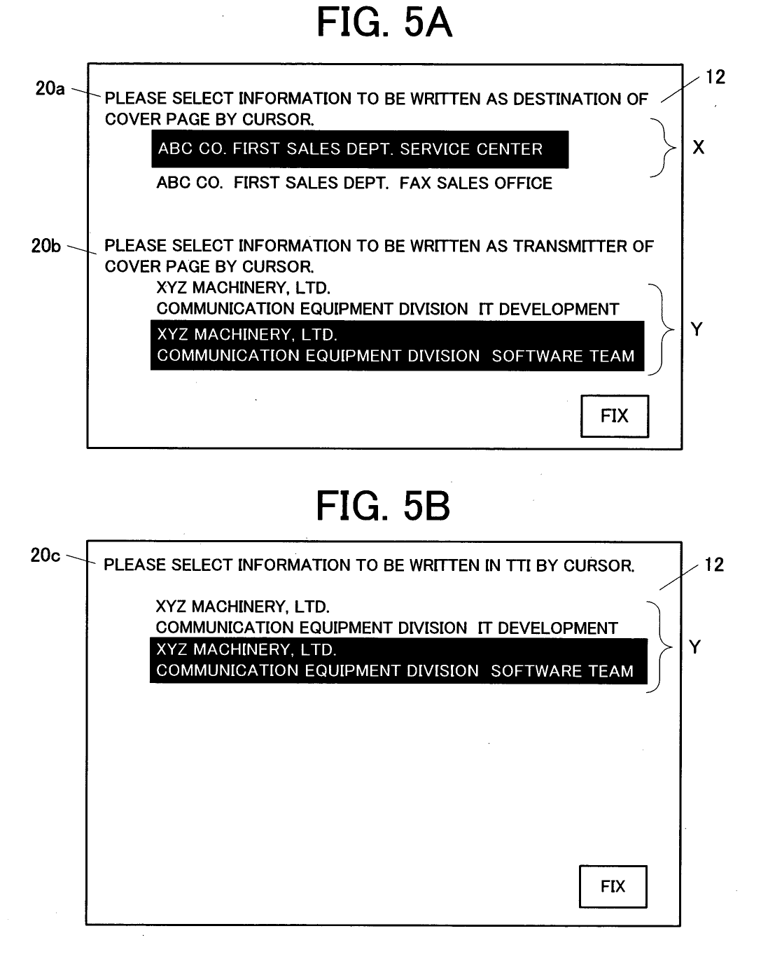

The network facsimile machine 1 acquires the information from the directory server 18 (step S3). Then, the network facsimile machine 1 displays acquired information X and Y as candidates of the cover page on the display 12 as shown in FIG. 5A in a manner that the information can be selected. FIG. 5A shows an example of a display displayed when the network facsimile machine 1 acquires as the information X corresponding to the destination facsimile number, ““o”=“ABC Co.”, “ou”=“First Sales Dept.” and “cn”=“FAX Sales Office”” and ““o”=“ABC Co.”, “ou”=“First Sales Dept.” and “cn”=“Service Center””, and receives as the information Y corresponding to the transmitter facsimile number, ““o”=“XYZ Machinery, Ltd.”, “ou”=“Communication Equipment Division” and “cn”=“IT Development”” and ““o”= “XYZ Machinery, Ltd.”, “ou”=“Communication Equipment Division” and “cn”=“Software Team”” from the directory server 18.

A description 20a for requesting the user to select information to be written as the destination of the cover page is displayed along with the information X corresponding to the destination facsimile number. A description 20b for requesting the user to select information to be written as the transmitter of the cover page is displayed along with the information Y corresponding to the transmitter facsimile number. By a prescribed screen switching operation, a screen shown in FIG. 5B is displayed on the display 12. The display 12 displays the screen shown in FIG. 5B in a manner that the information Y corresponding to the transmitter facsimile number acquired from the directory server 18 can be selected as a candidate of information to be embedded in the TTI. A description 20c for requesting the user to select the information to be written in the TTI is displayed along with the displayed information Y corresponding to the transmitter facsimile number.

When a highlighted cursor as shown in the drawing is moved by an operation of the user and a “fix” button is selected for selecting the displayed information (step S5: YES), image data of the original document set at the scanner 9 is scanned (step S6). Image data of a cover page is generated by including the information selected as the information to be written as the destination and the transmitter of the cover page at step S5. The generated image data is embedded in a front page of the image data generated at step S6. The image data of the TTI including the information selected as the information to be written in the TTI at step S5 is embedded in each page of the image data of the original document (including the image data of the cover page) (step S7). The image data including the TTI and the cover page is transmitted to the destination facsimile number designated at the transmission operation of step S1 (step S8).

Further, in case of accepting a keyword corresponding to the TSI at step S1, the processes of steps S2, S51, S52, S3, S4 and S5 are also executed on the accepted keyword. In the facsimile transmission protocol at step S8, the information acquired as a response of the keyword presented at step S2 is transmitted to the destination as the TSI along with the image data of the original document.

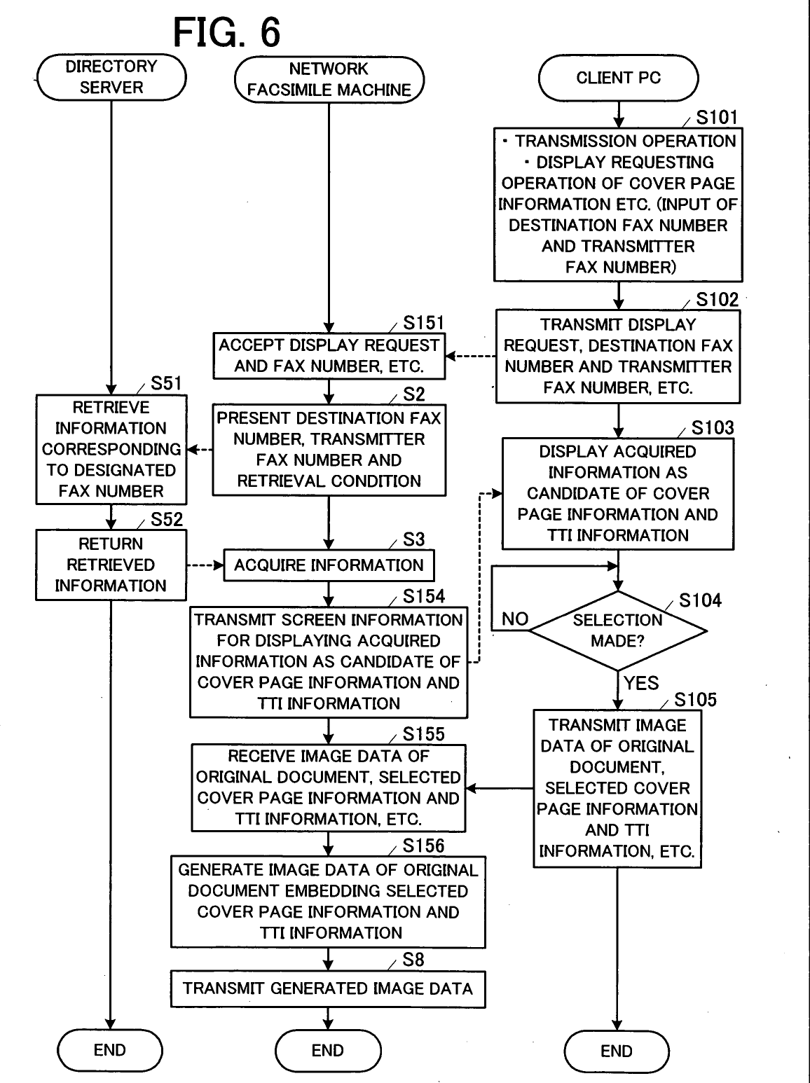

Referring to FIG. 6, a description will be made of a case in which the user transmits an original document from the client PC 17 by using the cover page adding function and the TTI adding function. Further, the same reference numeral is applied and the description is omitted for a process that is the same as the above-described process when the transmission is carried out from the network facsimile machine 1.

First, in addition to a general facsimile transmission operation such as an input operation of a destination facsimile number, a user of the client PC 17 carries out a prescribed operation for requesting a display of the cover page information and the TTI information (step S101). In the prescribed operation, as designation information for designating the information to be embedded in the image data of the transmission original document, the destination facsimile number and a transmitter facsimile number are designated by the input operation of the user separately with respect to the transmission operation. The designated destination facsimile number, the transmitter facsimile number and the display request or the like are transmitted to the network facsimile machine 1 (step S102).

Further, the destination facsimile number and the transmitter facsimile number are examples of the designation information. In place of the destination facsimile number and the transmitter facsimile number, a keyword including an appropriate character string or the like can be adopted. In case the TSI is registered in the database 18a of the directory server 18, in the prescribed operation, as the designation information for designating the information to be transmitted along with the image data of the transmission original document, a prescribed keyword (for example, an appropriate character string; can be the destination facsimile number or the like) corresponding to the TSI on the database 18a is designated by the input operation of the user. The client PC 17 and the network facsimile machine 1 can accept the keyword. The accepted keyword can be presented to the directory server 18 as the same designation information as the transmitter facsimile number and the registered TSI can be acquired.

The network facsimile machine 1 accepts a display request and the facsimile number of the cover page information and the TTI information or the like received from the client PC 17 (step S151). The network facsimile machine 1 presents the two facsimile numbers and the retrieval to the directory server 18, which is a remote device, by the LDAP or the like (step S2). Further, the retrieval condition is the same as when carrying out the facsimile transmission from the network facsimile machine 1.

Next, the processing operations of steps S51 and S52 of the directory server 18 and the processing operation of step S3 of the network facsimile machine 1 are carried out. Then, the network facsimile machine 1 transmits to the client PC 17, the screen information for displaying on a display of the client PC 17, the acquired information as a candidate of the cover page information and the TTI information in a manner that the information can be selected as shown in FIGS. 5A and 5B (step S154).

The client PC 17 that received the screen information displays on the display 12, the acquired information X and Y as a candidate of the cover page in a manner that the information can be selected as shown in FIG. 5A (step S103). By the operation of the user of the client PC 17, when the displayed information is selected (step S104: YES), the image data of the transmission original document, the information selected as the information to be written as the destination and the transmitter of the cover page and the information selected as the information to be written as the TTI are respectively transmitted to the network facsimile machine 1 (steps S105 and S155).

Next, the network facsimile machine 1 generates the image data of the cover page including the information received as the information to be written as the destination and the transmitter of the cover page. The generated image data is embedded in a front page of the image data of the original document. The image data of the TTI including the information received as the information to be written as the TTI is embedded in each page of the image data of the original document (including the image data of the cover page) (step S156). The image data including the TTI and the cover page is transmitted to the destination facsimile number designated in the transmission operation of step S101 (step S8).

Further, in case of accepting a keyword corresponding to the TSI at step S101, a series of the same processing operations are also executed on the accepted keyword. In the facsimile transmission protocol at step S8, among the information acquired as the response of the keyword presented at step S2, the network facsimile machine 1 transmits to the destination, the information selected at step S104 along with the image data of the original document as the TSI.

As described above, according to the network facsimile machine 1 of the first embodiment, the information of the transmitter (for example, a company name and a department name) and the information of the destination (for example, a company name and a department name) are registered in the database 18a of the directory server 18. Accordingly, a cover page or a TSI specific to each destination or each user of the network facsimile machine 1 can be embedded in the transmission original document by a simple operation. In case there exist a plurality of pieces of information associated with the designation information, the user can select a desired piece of information from the displayed plurality of pieces of information. As a result, there are various advantages. For example, suppose that the destination shares one facsimile machine by a plurality of departments and divisions. In this case, a plurality of departments and divisions can be registered in the database 18a by being associated with the facsimile number of the facsimile machine. Then, the user of the network facsimile machine 1 can easily add a cover page including detailed information such as the department and the division to the original document and transmit the original document.

Next, a description will be made of a network facsimile machine according to a second embodiment of the present invention. A network facsimile machine 1A of the second embodiment includes the same structure and the same function as the network facsimile machine 1 of the first embodiment. The second embodiment differs from the first embodiment in that the designation information for designating the information to be embedded in the image data of the transmission original document is a speed dial number and not a facsimile number (or an electronic mail address). The network facsimile machine 1A presents a speed dial number designated as the designation information to the directory server 18. As a response, the network facsimile machine 1A acquires corresponding information from the database 18a. Without requiring the selection operation of the user described in the first embodiment, the acquired information is applied as information of the cover page and the TTI. In the following, the same reference numeral is applied and the description is omitted for a structure and a processing operation that are the same as the first embodiment. Only the different parts will be described. Also in the second embodiment, the processing operation of the network facsimile machine 1A to be described with reference to the flowcharts is carried out in accordance with a command generated by the CPU 2 in accordance with the control program stored in the ROM 4.

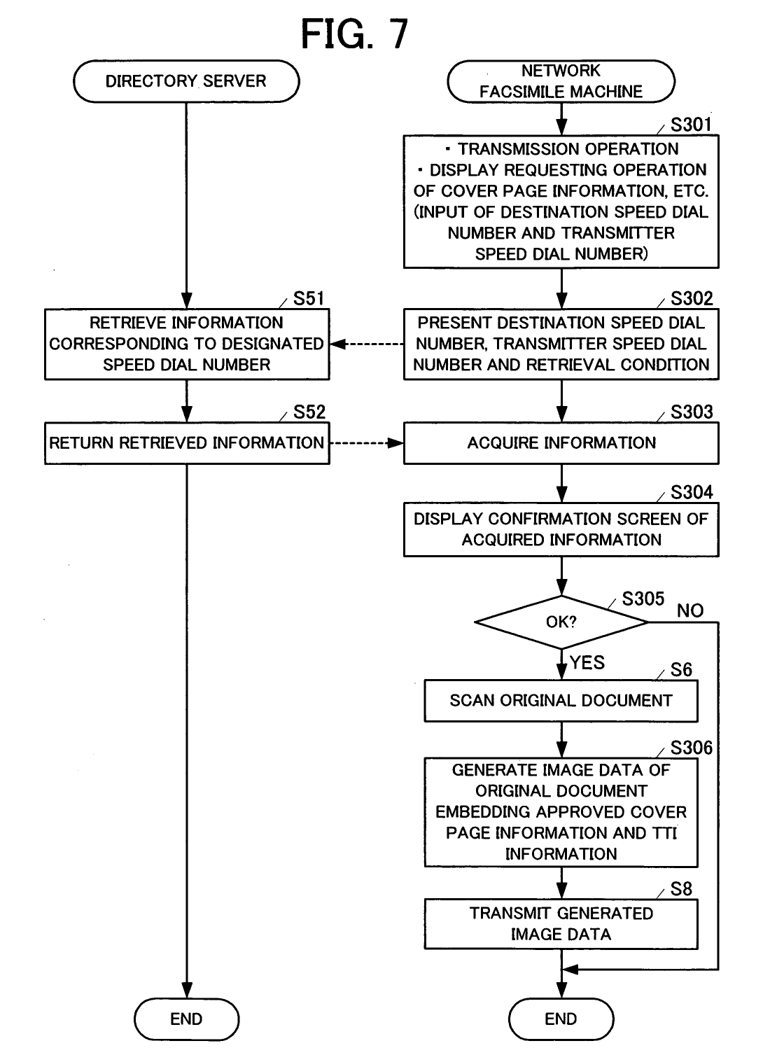

First, referring the flowchart shown in FIG. 7, a description will be made of a case in which the user transmits an original document by using the cover page adding function and the TTI adding function of the network facsimile machine 1A. Further, in the second embodiment, the transmission is carried out as the facsimile transmission. However, the transmission can also be carried out by the Internet facsimile transmission or other transmission methods.

The user sets an original document at the scanner 9. In addition to a general transmission operation such as an input operation of a destination facsimile number or the like, a prescribed operation is carried out for requesting a display of the cover page information and the TTI information. In the prescribed operation, as designation information for designating information to be embedded in the image data of the transmission original document, a speed dial number corresponding to a transmission destination (hereinafter referred to as a “destination speed dial number”) and a speed dial number corresponding to a transmitter (hereinafter referred to as a “transmitter speed dial number”) are designated by the input operation of the user. The network facsimile machine 1A accepts the speed dial numbers (step S301). Further, a speed dial number which a facsimile number is not registered is used here.

The destination speed dial number and the transmitter speed dial number are examples of the designation information. In place of these speed dial numbers, a keyword consisting of an appropriate character string or the like can be adopted. In case the TSI is registered in the database 18a of the directory server 18, in the prescribed operation, as the designation information for designating information to be transmitted along with the image data of the transmission original document, a prescribed keyword (for example, an appropriate character string; can be the destination speed dial number or the like) corresponding to the TSI on the database 18a is designated by the input operation of the user. The network facsimile machine 1A can accept the keyword and present the accepted keyword to the directory server 18 as the same designation information as the transmitter speed dial number. Then, the network facsimile machine 1A can acquire the registered TSI.

Next, the network facsimile machine 1A presents the accepted two speed dial numbers and a retrieval condition to the directory server 18, which is a remote device, by the LDAP or the like (step S302). The retrieval condition requests information attributing to the directory object including the speed dial number acquired at step S301. For example, the directory server 18 includes the database 18a as shown in FIG. 2. In case the network facsimile machine 1A accepts the destination speed dial number “109” and the transmitter speed dial number “102” as the designation information, the network facsimile machine 1A present to the directory server 18, a retrieval condition for retrieving “o”, “ou” and “cn”” of the directory object which ““speedDialNumber”=109”. As a response, the directory server 18 returns as a retrieval result, ““o”=“ABC Co.”, “ou”=“First Sales Depart.” and “cn”=“Service Center””. Furthermore, the network facsimile machine 1A presents to the directory server 18, a retrieval condition for retrieving ““o”, “ou” and “cn”” of the directory object which ““speedDialNumber”=102”. As a response, the directory server 18 returns as a retrieval result, ““o”=“XYZ Machinery, Ltd.”, “ou”=“Communication Equipment Division” and “cn”=“Software Team””.

The directory server 18 retrieves in the database 18a, a company name, a department name and a division name or the like of the destination or the transmitter, which is the information corresponding to the speed dial number designated by the network facsimile machine 1A, in other words, the information attributing to the directory object having the speed dial number as the attribute information (step S51). The directory server 18 returns the retrieved information as the retrieval result to the network facsimile machine 1A (step S52).

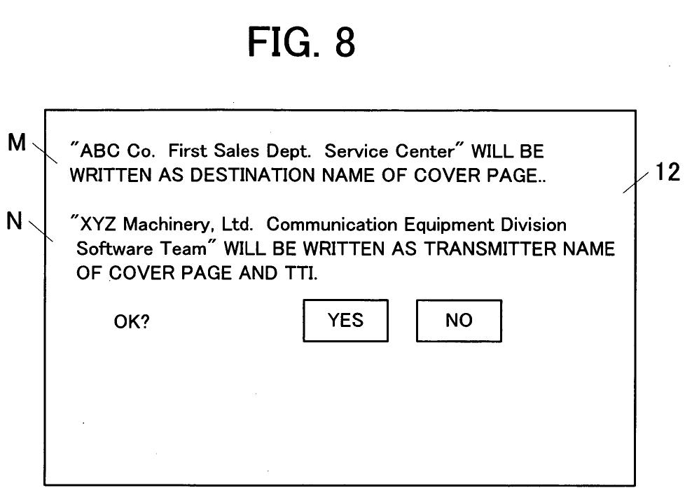

The network facsimile machine 1A acquires the information from the directory server 18 (step S303). The network facsimile machine 1A displays on the display 12 as shown in FIG. 8, acquired information M and N and a confirmation screen for confirming the user as to whether the acquired information M and N can be written as a destination name of the cover page and the transmitter name of the cover page and the TTI (step S304).

When an approval for the confirmation request is made by a prescribed operation of the user (step S305: YES), the image data of the original document set at the scanner 9 is scanned (step S6) Then, the image data of the cover page including the information approved as the information to be written as the destination and the transmitter of the cover page at step S305 is generated. The generated image data is embedded in a front page of the image data generated at step S6. Furthermore, the image data of the TTI including the information approved as the information to be written in the TTI at step S305 is embedded in each page of the image data of the original document (including the image data of the cover page) (step S306). Then, the image data including the TTI and the cover page is transmitted to the destination facsimile number designated at the transmission operation of step S301 (step S8). Further, in case the confirmation request is not approved at step S305, a series of the processing operation ends.

Further, in case of accepting the keyword corresponding to the TSI at step S301, the processing operation of steps S302, S51, S52, S303, S304 and S305 are also executed on the accepted keyword. Then, in the facsimile transmission protocol at step S8, the information acquired as the response of the keyword presented at step S302 is transmitted as the TSI to the destination along with the image data of the original document.

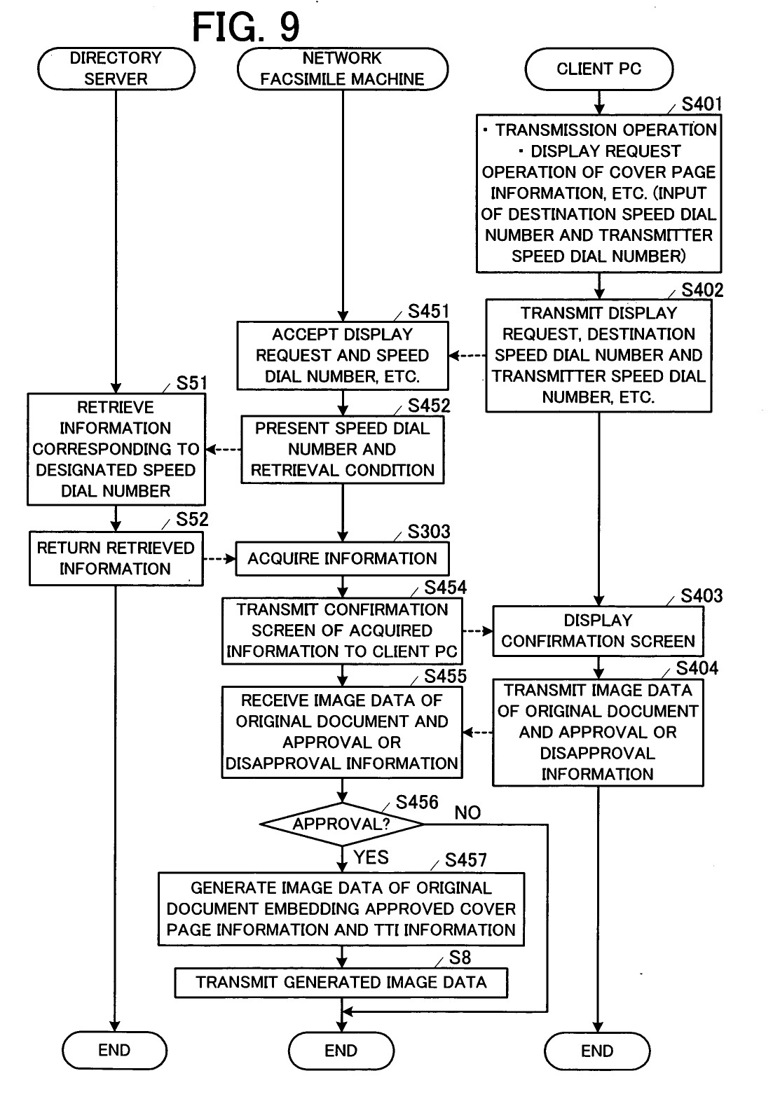

Next, referring to FIG. 9, a description will be made of a case in which the user transmits an original document from the client PC 17 by using the cover page adding function and the TTI adding function. Further, a same reference numeral is applied and the description is omitted for the processing operation that is the same as the above-described processing operation when the transmission is carried out from the network facsimile machine 1A.

In addition to a general transmission operation such as an input operation of the destination facsimile number, the user of the client PC 17 carries out a prescribed operation for requesting a display of the cover page information and the TTI information (step S401). In the prescribed operation, as the designation information for designating information to be embedded in the image data of the transmission original document, a speed dial number corresponding to a transmission destination (hereinafter referred to as a “destination speed dial number”) and a speed dial number corresponding to a transmitter (hereinafter referred to as a “transmitter speed dial number”) are designated by the input operation of the user. Then, the designated destination speed dial number, the transmitter speed dial number and the display request or the like are transmitted to the network facsimile machine 1A (step S402).

Further, the destination speed dial number and the transmitter speed dial number are examples of the designation information. In place of the destination speed dial number and the transmitter speed dial number, a keyword consisting of an appropriate character string or the like can be adopted. In case the TSI is registered in the database 18a of the directory server 18, in the prescribed operation, as the designation information for designating the information to be transmitted along with the image data of the transmission original document, a prescribed keyword (for example, an appropriate character string) corresponding to the TSI on the database 18a is designated by the input operation of the user. The client PC 17 and the network facsimile machine 1A can accept the keyword and present the keyword to the directory server 18 as the same designation information as the transmitter speed dial number. Then, the registered TSI can be acquired.

The network facsimile machine 1A accepts a display request and a speed dial number of the cover page information and the TTI information or the like received from the client PC 17 (step S451). The network facsimile machine lA presents the two speed dial numbers and the retrieval condition to the directory server 18, which is a remote device, by the LDAP or the like (step S452). The retrieval condition is the same as when carrying out the facsimile transmission from the network facsimile machine 1A as described above.

Next, the processing operations of steps S51 and S52 of the directory server 18 and the processing operation of step S303 of the network facsimile machine 1A are carried out. Then, the network facsimile machine 1A transmits to the client PC 17, screen information for displaying on the display of the client PC 17, the acquired information M and N along with the confirmation screen for confirming the user as to whether the acquired information M and N can be written as the destination name of the cover page and the transmitter name of the cover page and the TTI as shown in FIG. 8 (step S454).

The client PC 17 that received the screen information displays on the display 12, the acquired information M and N along with the confirmation screen for confirming the user as to whether the acquired information M and N can be written as the destination name of the cover page and the transmitter name of the cover page and the TTI as shown in FIG. 8 (step S403). By the prescribed operation of the user, when a determination of approval or disapproval is carried out on the confirmation request, information indicating such a fact is transmitted to the network facsimile machine 1A along with the image data of the transmission original document (step S404).

The network facsimile machine 1A receives from the client PC 17, the information designating approval or disapproval and the image data of the original document (step S455). In case the received information is information that designates approval (step S456: YES), the image data of the cover page including the information approved as the information to be written as the destination and the transmitter of the cover page is generated. The generated image data is embedded in a front page of the image data of the original document received from the client PC 17. Then, the image data of the TTI including the information approved as the information to be written in the TTI is embedded in each page of the image data of the original document (including the image data of the cover page) (step S457). Then, the image data including the TTI and the cover page is transmitted to the destination facsimile number designated in the transmission operation of step S401 (step S8). Further, at step S456, when a determination is made that the information is not information to be approved, a series of the processing operation ends.

Further, in case of accepting a keyword corresponding to the TSI at step S401, a series of the same processing operations are also executed on the accepted keyword. In the facsimile transmission protocol at step S8, among the information acquired as a response of the keyword presented at step S452, the network facsimile machine 1A transmits to the destination, the information selected at step S104 along with the image data of the original document as the TSI.

As described above, according to the network facsimile machine 1A of the second embodiment of the present invention, the user can add a cover page including detailed information such as a department and a division to an original document and transmit the original document by an even more simple operation. That is, compared with the network facsimile machine 1 of the first embodiment, since the selection operation is omitted, the operation is simplified. For example, in case the user uses frequently and remembers the content of the cover page or the TSI corresponding to the speed dial number, just by carrying out the designation operation of the speed dial number, an original document with the cover page and the TSI can be transmitted to the destination.

In the first and the second embodiments of the present invention, the cover page adding function and the TTI adding function have been described. A range in which the present invention can be applied is not limited to the cover page adding function and the TTI adding function. That is, if the information is information to be embedded in the transmission original document, by registering the information and the designation information corresponding to the information in the database 18a of the directory server 18, an adding function similar to the cover page adding function and the TTI adding function can be realized.

According to the first and the second embodiments of the present invention, the attribute information corresponding to the company name, the department name and the division name are acquired from the directory server 18 and the acquired attribute information is adopted as a part of the cover page information and the TSI information. However, the present invention is not limited to the company name, the department name and the division name. Detailed information such as a name of a person in charge can be registered in the database 18a of the directory server 18. By designating the attribute information, the detailed information can be acquired from the directory server 18.

According to the first and the second embodiments of the present invention, both the cover page and the TSI are embedded in the image data of the transmission original document. However, one of the cover page and the TSI can be embedded in the image data of the transmission original document. In case of embedding only the TSI in the image data of the transmission original document, the designation information designated by the user and the designation information presented to the directory server 18 by the network facsimile machine 1 can be one piece of information.

1. A network facsimile machine, comprising:
means for accepting designation information for designating information to be embedded in image data of a transmission original document;
means for presenting the accepted designation information to a remote device and acquiring information as a response; and
means for generating image data in which the acquired information is embedded in the transmission original document.

2. The network facsimile machine according to claim 1, further comprising means for embedding the acquired information as a part of a Transmit Terminal Identifier (TTI) of the transmission original document.

3. The network facsimile machine according to claim 1, further comprising means for embedding the acquired information as a part of a cover page of the transmission original document.

4. The network facsimile machine according to claim 1, further comprising means for selecting at least one piece of information from the acquired information which includes a plurality of information.

5. The network facsimile machine according to claim 4, further comprising means for embedding the selected information as a part of the Transmit Terminal Identifier (TTI) of the transmission original document.

6. The network facsimile machine according to claim 4, further comprising means for embedding the selected information as a part of a cover page of the transmission original document.

7. The network facsimile machine according to claim 1, wherein the remote device is a directory server.

8. The network facsimile machine according to claim 7, further comprising means for retrieving information in accordance with the accepted designation information.

9. A network facsimile machine, comprising:
means for accepting designation information for designating information to be transmitted with image data of an original document;
means for presenting the accepted designation information to a remote device and acquiring information as a response; and
means for transmitting the acquired information with the image data of the original document.

10. The network facsimile machine according to claim 9, further comprising means for transmitting a Transmitting Subscriber Identification (TSI) signal for transmitting the designation information.

11. The network facsimile machine according to claim 10, wherein the remote device is a directory server.

12. The network facsimile machine according to claim 11, further comprising means for retrieving information in accordance with the accepted designation information.

13. A network facsimile communication method, comprising the steps of:
accepting designation information for designating information to be embedded in image data of a transmission original document;
presenting the accepted designation information to a remote device and acquiring information as a response; and
generating image data in which the acquired information is embedded in the transmission original document.

14. The network facsimile communication method according to claim 13, further comprising a step of embedding the acquired information as a part of a Transmit Terminal Identifier (TTI) of the transmission original document.

15. The network facsimile communication method according to claim 13, further comprising a step of embedding the acquired information as a part of a cover page of the transmission original document.

16. The network facsimile communication method according to claim 13, further comprising a step of transmitting the generated image data.

17. The network facsimile communication method according to claim 13, further comprising a step of retrieving information by the remote device in accordance with the accepted designation information.

18. The network facsimile communication method according to claim 17, further comprising a step of selecting at least one piece of information from a plurality of the retrieved information.

19. The network facsimile communication method according to claim 13, further comprising a step of displaying the acquired information.

20. The network facsimile communication method according to claim 19, further comprising a step of stopping the generation of the image data in accordance with a command.
